(19) United States
(12) Patent Application Publication
(10) Pub. No.: US 2006/0132430 A1
(43) Pub. Date: Jun. 22, 2006

(54) Color-changing electronic signage

(75) Inventors: Theodore K. Ricks, Rochester, NY (US); Megan L. Weiner, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/021,766

(22) Filed: Dec. 21, 2004

(51) Int. Cl. G09G 3/34

(52) U.S. Cl. 345/108

(57) ABSTRACT

An electronically updatable display having an electronically updatable display media with two or more color sets is disclosed, wherein the viewed color sets, and the image, are changeable.

### FIELD OF THE INVENTION

The present invention relates to a rewritable, colored electronic display, and signage systems including such displays.

### BACKGROUND OF THE INVENTION

Electronic signs are becoming popular in retail stores in order to keep pricing and sale information as current as possible. For example, prices can be kept up-to-date without having to reprint new price sheets whenever there is a sale or price change. The customer benefits by having the up-to-date information they need about the product pricing, and the retailer benefits by having programmable information that can be readily changed by various electronic means. Electronic signage is also increasingly used in large displays, such as billboards.

Electronic signs have been made using traditional display technologies, such as cathode ray tubes (CRTs), liquid crystal displays (LCDs), or plasma displays. These technologies provide dynamic, full-color imagery, but in return require complex, expensive electronics and constant power, increasing the weight, size, and cost of the signage including such displays. The advent of bistable, reflective display technology has enabled a new breed of electronic sign, which is capable of maintaining images indefinitely, without the constant application of power. Many bistable display technologies are well suited to reduced electronics in the form of a passive matrix drive system, or a direct drive system which utilizes an electronic “printhead” that is capable of updating display media as it is physically moved past the head. The use of reflective, bistable display technologies combined with either the electronic printhead or passive matrix systems, enables signage to be made with both reduced electronics and power consumption, and completely unique form factors.

Despite the many developments in display technologies, it is still very difficult to get high quality, changeable color from a display system, particularly reflective display systems. Color-change has only been possible on a full color system, wherein full color capabilities are added through the use of either red-green-blue color layer stacking or color filters. Both of these approaches raise the product cost due to increased electronics, added layers in the system, or both. Further, they can add additional weight and size to the system. Such systems further suffer from light loss because the use of multiple layers or color filters blocks out some of the light entering the system, reducing the overall brightness of the display, and typically producing poor colors.

There are systems that attempt to provide color to the display without the loss of brightness or reduction in color quality by offering bi-chromic, or two-color, display systems. Bi-chromic systems can be made with very high quality colors, excellent brightness, and good contrast. Typical bi-chromic color combinations, or “sets,” are green and black, gray and blue, or black and white, but an almost infinite array of combinations is available. Bi-chromic systems enable the use of color, but once a particular color set has been selected for the display, it cannot be changed without physically changing the display.

Another method of applying more than one color to a display is the use of spot color. Spot color uses one color set for the majority of the display, but includes one or more areas of a different color set on the display. In some systems the spot color areas can be turned on and off, enabling a general appearance change to the display, but the additional color or colors are limited to the specific areas and color choices initially built into the display.

In US 2003/0071936, Niiyama et al. discloses the use of a color filter layer between two switchable layers. This system enables an entire display to be electronically switched from black and white, to a bright red (or other tri-color combinations). This is an improvement over the spot color in that the area of color is not limited, but it maintains the limitation of only having only two color set options, and it adds an entire layer of electronics.

Another option for a color changing display is to use mechanically indexed, scrolled paper. Scrolling displays offer an option for remotely changing the color of a sign, wherein one printed image is exchanged for a different printed image by scrolling through preprinted choices. A portion of a loop or scroll of material that is pre-printed with an array of images is viewed through a window. When a change in content or color is required, the system mechanically indexes the scroll to make a different portion visible in the window. This system enables an infinite array of high-quality colors to be used in an inexpensive system, but is not able to be remotely updated with new information. Once the scroll is printed, the information is set, and can only be changed by replacing the scroll with a new scroll.

There is a need for a display system that is remotely updatable, and that has the ability to remotely select from a variety of high-quality colors. Desirably, the display could also be bistable, and could have one or more of minimum weight, size, cost or power requirements.

### SUMMARY OF THE INVENTION

An electronically updatable display is disclosed, wherein the display includes an electronically updatable display media having two or more areas, wherein at least two areas have a different color set; and at least one view area, wherein at least a portion of the media is viewable through the view area, and wherein the view area and the media are movable relative to one another.

### ADVANTAGES

The electronically updatable, color-changing display can be used to display images in a variety of high-quality colors, wherein both the content and color of the image can be updated remotely. The system can change the color of all or a portion of the display, and can enable multiple viewing areas of the display to be the same or different colors. The system can provide high quality color. The system can use minimal power. The system can be lightweight, small, have a reduced cost, or a combination thereof.

### BRIEF DESCRIPTION OF THE DRAWINGS

The invention as described herein can be understood with reference to the accompanying drawings as described below:

FIGS. 1a and 1b are schematic front views of a display featuring stationary media with areas of two color sets and a single, movable view area;

FIG. 2a is a front view of a one-sided, color-changing display featuring movable media, a stationary view area, and a first color set visible;

FIG. 2b is a cross-sectional view of FIG. 2a;

FIG. 3a is a front view of the one-sided, color-changing display of FIG. 2a with portions of the first and second color set visible;

FIG. 3b is a cross-sectional view of FIG. 3a;

FIG. 4a is a front view of the one-sided, color-changing display of FIG. 2a with the second color set visible;

FIG. 4b is a cross-sectional view of FIG. 4a;

FIG. 5a is a front view of a two-sided, color-changing display featuring movable media, a stationary view area, and the second color set visible;

FIG. 5b is a cross-sectional view of FIG. 5a;

FIG. 5c is a back view of the two-sided, color-changing display of FIG. 5a with the second color set visible;

FIG. 6a is a front view of the two-sided, color-changing display of FIG. 5a with the second color set visible;

FIG. 6b is a cross-sectional view of FIG. 6a;

FIG. 6c is a back view of the two-sided, color-changing display of FIG. 6a with the first color set visible;

FIG. 7a is a front view of a single-sided, color-changing display featuring movable, translucent media, a stationary view area, and a first color set, and a second color set, wherein a combination of the first and second color sets is visible; and

FIG. 7b is a cross-sectional view of FIG. 7a.

The drawings are exemplary only, and depict various embodiments of the invention. Other embodiments will be apparent to those skilled in the art upon review of the accompanying text.

### DETAILED DESCRIPTION OF THE INVENTION

An electronic, rewritable display can be used in a signage system. The display can include one or more sheets of display media capable of displaying an electronically updateable image. The display media can include two or more areas, each featuring a different combination of two or more colors, hereafter referred to as a “color set.” As used herein, “media” can refer to a single piece of media having two or more color sets, or multiple pieces of media, wherein each piece of media has one or more color sets. The media pieces can be spatially separated, joined, butted, or overlapped. An image can be produced on the display by setting one or more area of the display to a first color on a first section of media, and remaining areas of the display to a different color. One portion of the display media can be completely or partially transparent. The display can include a case, which enables only a portion of the media to be visible at a given time. The area of the display media that is visible at any given time is hereafter referred to as the “view area.” The perceived color of the display can be changed by changing the portion of the display media that is visible in the view area. The perceived color of the display can be electronically selectable by incorporating an automated system for moving the media relative to one or more view areas. The display media or the view area can be movable. The portion of the media visible in the view area can contain all or a portion of one or more color sets.

The display media can be completely written using permanently attached drive electronics, or can be written in portions by a writehead capable of moving relative to the media. The information written to the display media can be viewed from one or more view directions. The media can be in the form of a sheet, loop, scroll, or any other arrangement.

The display can include rewritable, electronic display media. Such display media can include, for example, electrochemical materials; electrophoretic materials, including those manufactured by Gyricon, LLC of Ann Arbor, Mich., and E-ink Corporation of Cambridge, Mass.; electrochromic materials; magnetic materials; and liquid crystal materials. The liquid crystal materials can be twisted nematic (TN), super-twisted nematic (STN), ferroelectric, magnetic, or chiral nematic liquid crystal materials. Chiral nematic liquid crystals can be polymer dispersed liquid crystals (PDLC). Suitable chiral nematic liquid crystal materials include a cholesteric liquid crystal disclosed in U.S. Pat. No. 5,695,682, and Merck BL112, BL118 or BL126, available from EM Industries of Hawthorne, N.Y.

According to various embodiments, the display element can maintain a desired image, such as text, graphics, symbols, or characters, without power by using a bistable material. This reduces power requirements of the display, and can improve the life of the display where the display has a self-contained power source, such as by a battery. Bistable displays can be formed by methods known in that art of display making. Suitable bistable materials can include electrochemical materials; electrophoretic materials; electrochromic materials; magnetic materials; and chiral nematic liquid crystal materials. Wherein the bistable material is liquid crystal material, a support having a first conductive layer can be coated with the bistable material or a pre-formed layer of the bistable material can be placed over the first conductive layer. A second conductive layer can be formed over the bistable material to provide for application of electric fields of various intensity and duration to the bistable material to change its state from a reflective state to a transmissive state, a transmissive state to a reflective state, or from any state to a desired grey scale level. The bistable materials can maintain a given state indefinitely after the electric field is removed. According to various embodiments, one or more conductive layer can be provided external to the bistable media.

The first conductive layer can be patterned, for example, into parallel lines. The second conductive layer can be patterned non-parallel to the patterning of the first conductive layer such that the intersection of the first conductive layer and the second conductive layer forms a pixel. The bistable material in the pixel changes state when an electric field is applied between the first and second conductive layers. The second conductive layer can be patterned in the form of individual pixels.

The second conductive layer can be electrically conductive segments formed over the bistable material layer by thick film printing, sputter coating, or other printing or coating means. The conductive segments can be any known aqueous conductive material, for example, carbon, graphite, or silver. An exemplary material is Electrodag 423SS screen printable electrical conductive material from Acheson Corporation. The conductive segments can be arranged to form pixels of any shape, numbers 0-9, a slash, a decimal point, a dollar sign, a cent sign, or any other character or symbol.

The optical state of the bistable material between the first conductive layer and the second conductive layer can be changed by selectively applying an electrical drive signal across the bistable material. This signal can be a voltage, current, or any combination thereof. The signal can be applied to the second conductive layer and to the first conductive layer by direct or indirect contact, if they are present in the media. For any conductive layer not present in the media, the signal can be applied to selected areas of the bistable material through direct or indirect contact of one or more external electrode to the bistable material. Once the optical state of the bistable material has been changed, it can remain in that state indefinitely without further power being applied to the conductive layers. Methods of forming various bistable display elements are known to practitioners in the art. For example, bistable liquid crystal displays are taught in U.S. Ser. No. 10/134,185, filed Apr. 29, 2002 by Stephenson et al., and U.S. Ser. No. 10/851,440 filed May 21, 2004, to Burberry et al.

Depending on the material selected for the display, color can be added through the use of filters, colored translucent polymeric films, and direct coloration of the display material by manipulation of the material or addition of colorants thereto. For example, when the display material is a liquid crystal material, different colors can be achieved by adjusting the pitch of the liquid crystals, or by adding a colorant thereto.

Chiral nematic liquid crystal refers to the type of liquid crystal having finer pitch than that of twisted nematic and super twisted nematic liquid crystals. Chiral nematic liquid crystal formulations can be made by adding chiral agents to host nematic liquid crystals. Chiral nematic displays are bistable in the absence of a field, having two stable textures, a reflective planar texture and a weakly scattering focal conic texture. In the planar texture, the helical axes of the chiral nematic liquid crystal molecules are substantially perpendicular to the substrate upon which the liquid crystal is disposed. In the focal conic state, the helical axes of the liquid crystal molecules are randomly oriented. Adjusting the concentration of chiral dopants in the chiral nematic material can modulate the pitch length of the liquid crystals and affect the wavelength of radiation reflected, altering the observed color of the liquid crystal. The chiral dopant added to the liquid crystal can be chosen based on several characteristics, including chemical compatibility with the nematic host, helical twisting power, temperature sensitivity, and light fastness. Many chiral dopant classes are known, as taught, for example, in G. Gottarelli and G. Spada, Mol. Cryst. Liq. Crys., 123, 377 (1985), G. Spada and G. Proni, Enantiomer, 3, 301 (1998), and references cited therein. Chiral dopants can include 1,1-binaphthol derivatives; isosorbide and similar isomannide esters disclosed in U.S. Pat. No. 6,217,792; TADDOL derivatives disclosed in U.S. Pat. No. 6,099,751; and pending spiroindanes esters disclosed in U.S. patent application Ser. No. 10/651,692 by T. Welter et al., filed Aug. 29, 2003.

The pitch length of the liquid crystal materials can be adjusted based upon the following equation (1):
λₘₐₓ=nₐᵥp₀
where λₘₐₓ is the peak reflection wavelength, that is, the wavelength at which reflectance is a maximum, nₐᵥ is the average index of refraction of the liquid crystal material, and p₀ is the natural pitch length of the chiral nematic helix. Definitions of chiral nematic helix and pitch length, and methods of measurement, are known to those skilled in the art, and can be found, for example, in L. M. Blinov, Electro-optical and Magneto-Optical Properties of Liquid Crystals, John Wiley & Sons Ltd., 1983. The pitch length can be modified by adjusting the concentration of the chiral material in the liquid crystal material. For most concentrations of chiral dopants, the pitch length induced by the dopant is inversely proportional to the concentration of the dopant. The proportionality constant is given by the following equation (2):
p₀=1/(HTP·c)
where c is the concentration of the chiral dopant and HTP is the proportionality constant.

Alternately, a liquid crystal material layer can include a light absorbing colorant, for example, an absorber dye. The colorant can selectively absorb scattered light from the planar state or focal conic state. Colorants can include dyes, pigments, or a combination thereof. The colorant can absorb selected wavelengths of light, improving the display quality. One or more colorant can be present in the liquid crystal, a binder for the liquid crystal such as a polymer, or both. The colorant can be chosen to absorb light of shorter wavelengths than a selected reflection wavelength of the liquid crystal. Any amount of colorant can be used, so long as it does not interfere with the display capabilities of the liquid crystal material. For example, colorant can be added in an amount of from 0.1 weight % to 5 weight % of the liquid crystal material.

Suitable colorants can be miscible with the liquid crystal material. Examples of suitable colorants can include, but are not limited to, anthraquinone dyes such as Sandoplast Blue 2B from Clariant Corporation; phthalocyanine dyes such as Savinyl Blue GLS from Clariant Corporation or Neozapon Blue 807 from BASF Corporation; methine dyes such as Sandoplast Yellow 3G from Clariant Corporation; metal complex dyes such as Neozapon Yellow 157, Neozapon Orange 251, Neozapon Green 975, Neozapon Blue 807 or Neozapon Red 365 from BASF Corporation; and Neopen Blue 808, Neopen Yellow 075, Sudan Orange 220 or Sudan Blue 670 from BASF Corporation. Suitable colorants can also include various dyestuffs suitable for resin coloring and dichromatic liquid crystal display, such as SPR RED1 by Mitsui Toatsu Senryo Co., Ltd.; and SI-424 or M-483 by Mitsui Toatsu Senryo Co., Ltd. Other suitable colorants, including dyes and pigments, will be apparent to practitioners in the art.

A light absorbing material, called a dark layer, can be positioned on a side of the liquid crystal material opposing the incident light. In the fully evolved focal conic state the cholesteric liquid crystal is transparent, passing incident light, which is absorbed by the dark layer to provide a colored, typically black, image. The dark layer can be a radiation reflective layer or a radiation absorbing layer of any color, so long as it provides a contrast to the liquid crystal in the planar state. The dark layer can include milled nonconductive nanopigments having a diameter less than 1 micron. The dark layer can include multiple pigment dispersions. Pigments suitable for use in the dark layer can be any colored materials that are not soluble in the medium in which they are incorporated. Suitable pigments include those described in Industrial Organic Pigments: Production, Properties, Applications by W. Herbst and K. Hunger, 1993, Wiley Publishers. These include, but are not limited to, pigments including azo pigments such as monoazo yellow and orange, diazo pigments, naphthol pigments, naphthol reds, azo lakes, benzimidazolone pigments, diazo condensation pigments, metal complexes, isoindolinone and isoindolinic pigments, polycyclic pigments such as phthalocyanine, quinacridone pigments, perylene pigments, perinone pigments, diketopyrrolo-pyrrole pigments, thioindigo pigments, and anthriquinone pigments such as anthrapyrimidine.

Different color sets can be formed on the display media by the material and color selection of the second conductive layer formed over the display material layer. For example, the use of carbon and silver conductive materials can result in different display media color sets when used in combination with the same coated, chiral nematic liquid crystal dispersion and color contrast layer. By using different conductive layer materials, a single media piece can be formed having two or more areas, at least two areas having different color sets.

Two or more display media pieces, at least two of the media pieces having different color sets, can be combined into a single media piece by any joining means, for example, taping, splicing, gluing, stitching, clamping or stapling. Two or more media pieces featuring different color sets can be joined in this manner to form a sheet, roll, or scroll having two or more areas of different color sets. A desired image can be formed on the display media by selectively changing the optical state of portions or all of the display media. Writing only portions of the display media can be accomplished by an active or passive drive writing selected sections or all of the display media, or by passing the display media past one or more electrodes, hereafter referred to as a “writehead.” The writehead can be designed to interact with the display media to apply the appropriate drive signal to change selected areas of the display media. The display media and writehead can move relative to each another. The writehead can be sized to cover one dimension of the display media, for example, the width of the media, or two or more writeheads can be used together to cover the desired portion of the media. The writehead can be made large enough to address the entire piece of media at once, in which case relative motion of the writehead and media is unnecessary, and the writehead can write all or a portion of the media at a time, for example, by use of an active or passive drive matrix. The writehead can be permanently or removably attached to the media.

The writehead can be aligned with a specific location on the media; a fiducial on the media; an aperture in the media; a feature on or in a layer of the media, for example, in the first or second conductor; or any other characteristic of the display media. The electrodes can be on the view side, back side, or both sides of the media. The writehead can be located on the view side of the media, the back side of the media, or both. The writehead can consist of two separate pieces when the writehead is located on both sides of the media, wherein the pieces can move simultaneously relative to the media. The writehead can be placed in direct or indirect contact with the conductive layers on the media.

When it is desirable to update the image on the display, the writehead can be aligned with a desired area of the display media, and the writehead can apply an appropriate drive signal to the display media to change all or a portion of the display to the desired image. The accuracy of the written media can be checked by an optical reader. The optical reader can be present on the media, on the writehead, or attached to a case surrounding all or a portion of the display or display elements. When a writehead is used to address the media, the media and writehead can be moved relative to each other to allow the writehead to address various sections of the media. The media can form a loop, such that the writehead can continuously address the entire display. If the media forms a scroll or sheet, the media can include a block, or the writehead can include sensors to detect the beginning and ending of the media, to prevent overdriving of the writehead.

The writehead drive signal can be provided by a display drive source, for example, a circuit board. The circuit board can be attached to the display media or writehead. The display drive source can include an internal power source, such as a battery, or can be connected to an external power source, for example, a battery or an electrical circuit. The display drive source can be connected to the media or writehead physically. The display drive source can be electrically connected to the media or writehead directly or through some secondary connections, such as wires. The data for forming an image can be provided by a computer through wired or wireless communication with the display drive source, or directly to the writehead. The display including the display media can further include a case. The case can conceal one or more portions of the display media from view, forming one or more view areas. The case can additionally enclose portions of one or more of the display media, writehead, and any associated electronics, for example, a display drive source. The writehead can also be a separate device, and can write the display media before the display media is placed in the case, or after. The case can be any material, for example, plastic, paper, metal, ceramic, liquid, gelatin, view obstructing gas, or any combination thereof. The case can have any shape, including, but not limited to, square, rectangular, octagonal, round, cylindrical, spherical, or amorphous. The case can be two- or three-dimensional. The case can be rigid, semi-rigid, flexible, liquid, or gaseous. The case can be opaque, translucent, transparent, or have sections with varying degrees of opacity from opaque to transparent, wherein a transparent area can coincide with a view area. The view area can be a transparent portion of the case, or an opening through the case.

The view area and the media can be moved relative to each other. The media can be held stationary and the view area moved. When the media is held stationary, the media can be written by permanently attached, conventional electronics capable of writing all or a portion of the entire display, or a writehead. The writehead can move with the view area, or independently therefrom. The view area can be stationary and the media moved past the view area to change the view area of the display. When the media is moved, the writehead can be stationary and the media can be written as it moves past the writehead, or the writehead can also move relative the media. The media or view area can be moved constantly or at intervals to show updated information. The portion of the media visible in the view area can have a single color set, or can include all or a portion of two or more color sets.

One or more driving force sources can impart relative motion between the media and the writehead, the media and the view area, or both. Each driving force source can be incorporated into the case, the writehead, the media, or a combination thereof. The drive force on the media, writehead, or view area can be an external roller, belt, or wheel powered by a motor, battery, other power source, manual labor, or gravity.

One or more pieces of display media can be combined with a writehead, drive electronics, and an optional case to form a display. The display can be an integrated unit, groups of individual components, or various combinations thereof. An integrated unit can provide a path to guide movement of the media, view area, writehead, or any combination thereof.

The display can be understood with reference to certain embodiments including a cholesteric liquid crystal display element, as depicted in the Figures and described below.

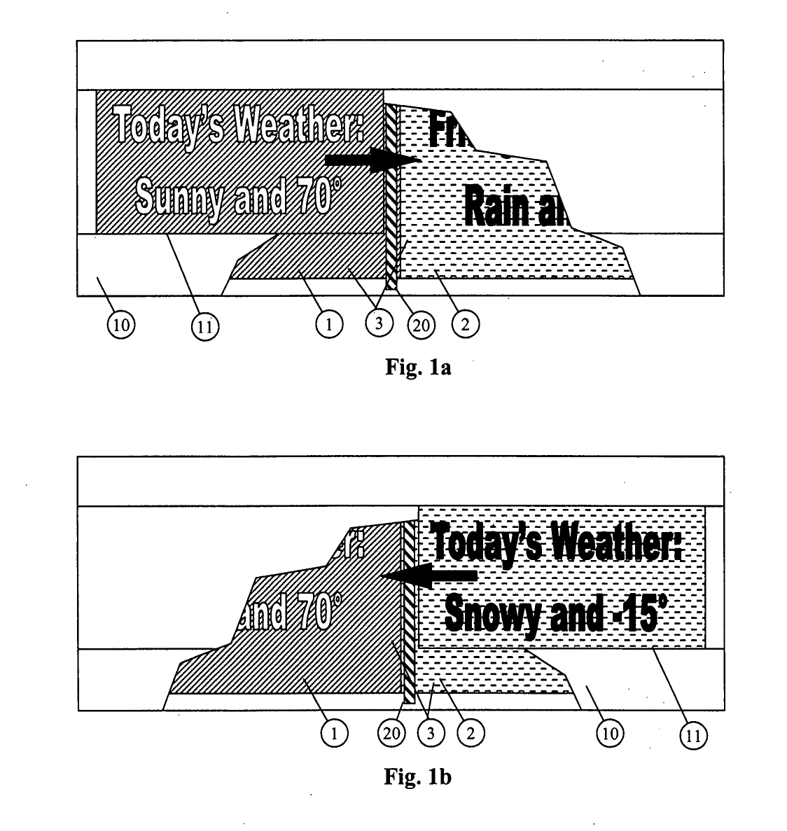

FIGS. 1a and 1b are front views of an electronically addressable, single-sided, reflective, color-changing display with stationary media 3 and a movable view area 11. In this embodiment, the media 3 has a first colored section 1, which features a first color set, and a second colored section 2, which features a different color set. The two colored sections are shown as a single piece of media, but they can be two discrete pieces. The display can be enclosed in a case 10 which has a view area 11, through which a portion of the media 3 can be seen. The view area 11 can be moved to display a first colored section 1, a second colored section 2, or any combination of the two. The display can have a writehead 20. The writehead can be stationary, movable with the view area 11, or movable independent of the view area 11. FIG. 1a shows the view area 11 in a first position, in which the first colored section 1 is visible, and the second colored section 2 is hidden. The view area 11 can be moved, and the media 3 can be updated with new information using the writehead 20. FIG. 1b shows the view area 11 in a second position, showing the updated information on the second colored section 2 while hiding the first colored section 1. The media can be written before placement in a display case, and the media and/or viewing area moved to display different portions of the pre-written media.

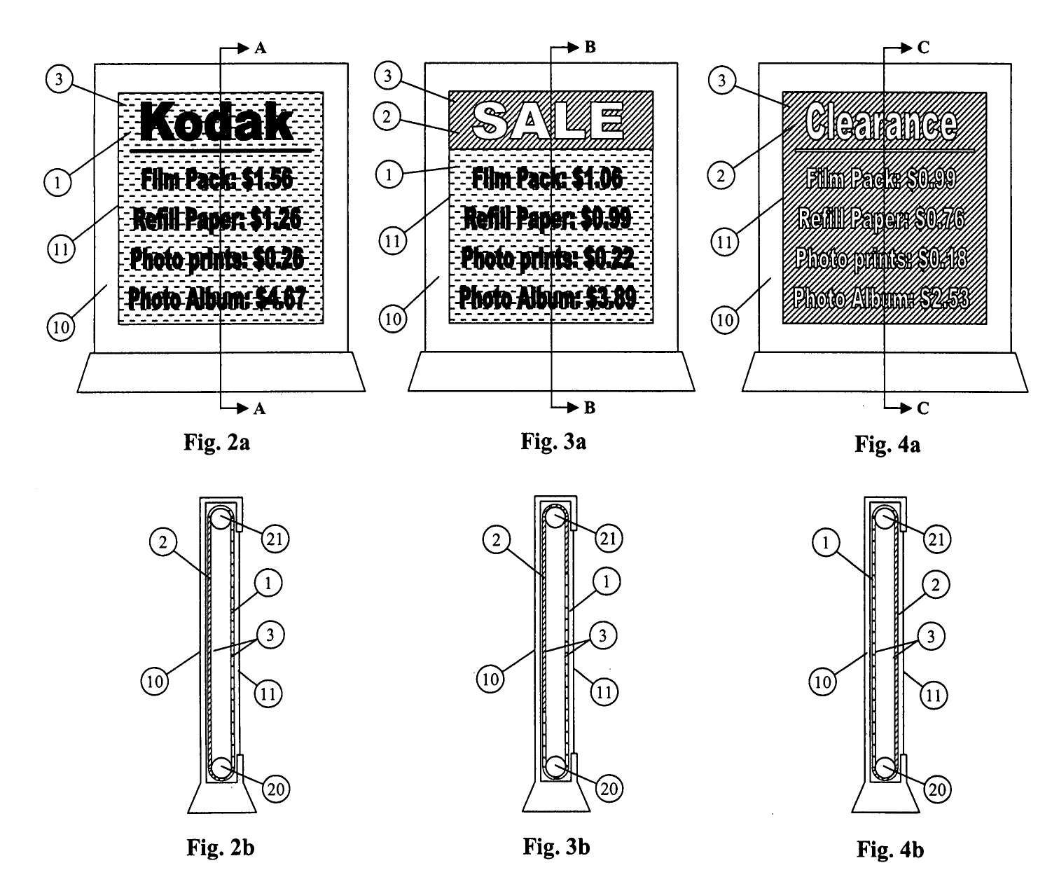

FIGS. 2a, 3a, and 4a are front views of a single-sided, reflective, color-changing display with a stationary view area 11 and movable media 3. FIGS. 2b, 3b, and 4b are cross-sections of the corresponding displays in corresponding color states. The display shown has the media 3 configured into a loop, half of which is a first colored section 1 and the other half of which is a second colored section 2. The media drive mechanism 21 can be a powered roller that can control the mechanical position of the media 3 relative to view area 11. The drive mechanism 21 can move the media past an electronic writehead 20, which updates the media 3 with a desired image. FIGS. 2a and 2b show the display with the media 3 positioned in view area 11 such that only the first colored section 1 is visible. FIGS. 3a and 3b show the same display when the media 3 has been positioned such that a portion of the first colored section 1 and a portion of the second colored section 2 are visible in view area 11. FIGS. 4a and 4b show the display in yet another configuration, where only the second colored section 2 is visible in view area 11. Although this embodiment shows only two color sets on the media 3, more can be used. The system is not limited to use of reflective media only. Transmissive, emissive, or transflective medias can also be used. Additionally, the display is not limited to a flat configuration. It can be curved, faceted, or have any other topography, especially where a flexible display media is used.

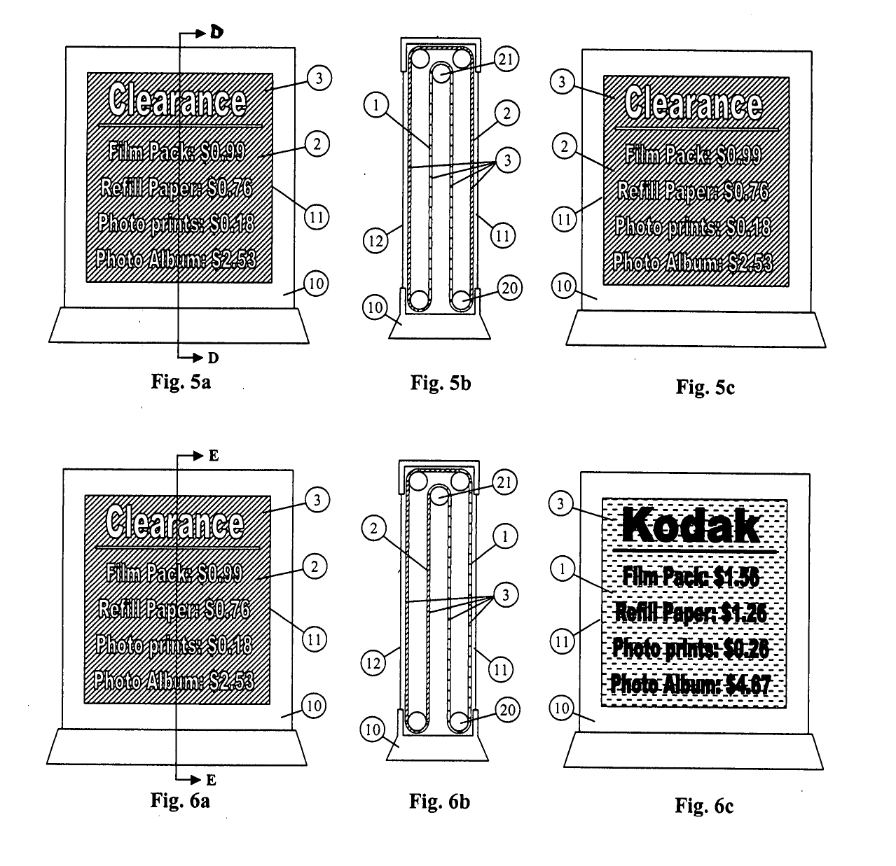

FIGS. 5a through 6c are assorted views of a two-sided, reflective, color-changing display with a stationary view area 11 and movable media 3. FIG. 5a depicts the first side of the display with a second colored section 2 visible. FIG. 5b is a schematic cross-section of this same display in this configuration. FIG. 5c depicts the second side of the display with a second colored section 2 visible. FIGS. 6a through 6c are of the same display, with the first colored section 1 visible from the second side of the display. As with the single-sided configuration, more than two color sets can be used and the display can have various configurations besides a flat display. Additionally, the display format can be expanded to include any number of view areas 11. Alternate media paths can be used to enable any portion or combination of portions of media color sets to be visible in a given view area.

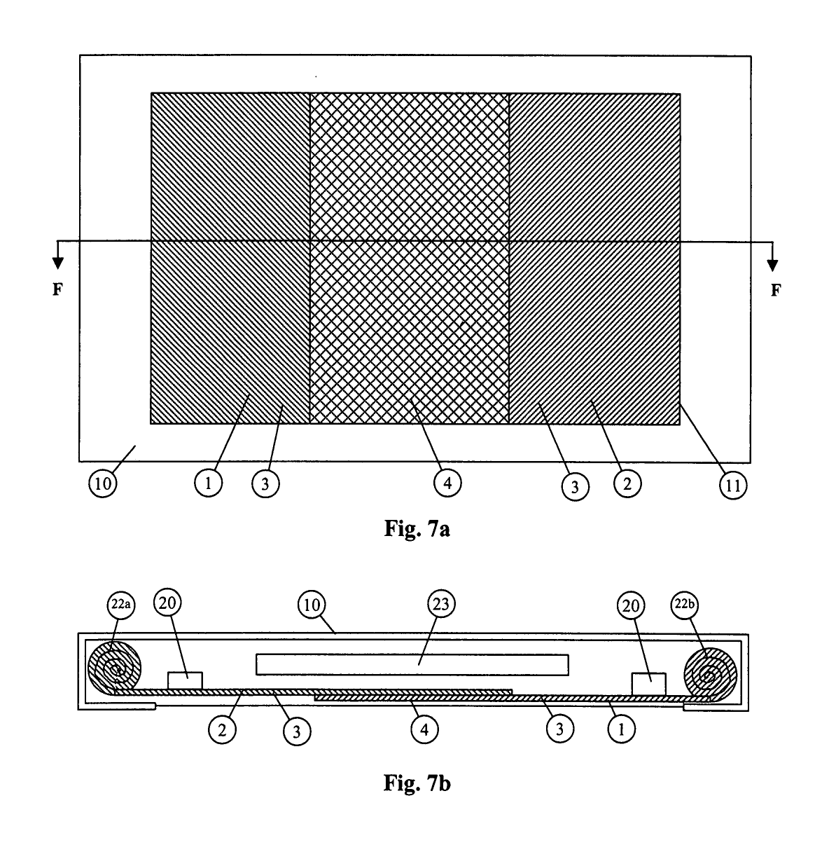

FIG. 7a is a front view of a one-sided, transflective, color-changing display with capability to overlap first and second colored sections 1,2 to form a third, composite color section 4. FIG. 7b is a cross-section of this display with an optional backlight 23. In this configuration, two pieces of media 1 are rolled into scrolls 22, which can be individually extended and addressed by a writehead 20. This configuration embodies one scroll 22a made entirely of a first color section 1, and a second scroll 22b made entirely of a second color section 2. However, each scroll 22 could be divided into multiple colored sections. In the situation that at least one of the color sets is at least partially transmissive, the two scrolls 22 can be overlapped to form a third color set 3, which is a combination of the first and second sections 1,2. In the situation that both scrolls 22 are at least partially transmissive, an optional light source 23 can be added to increase display brightness. Two or more writeheads can be used in this configuration, wherein each media can have a separate writehead.

Various configurations of display media, view area, and writehead have been presented. One or more display media piece, view area, and writehead can be combined in any manner to achieve the desired effect of a display with two or more electronically updatable color sets.

The invention has been described in detail with particular reference to certain preferred embodiments thereof, but it will be understood that variations and modifications can be effected within the spirit and scope of the invention.

Parts List

1 first colored section of media

2 second colored section of media

3 display media

4 third colored section of media

10 display case

11 view area

20 electronic writehead

21 media drive mechanism

22a,b display media scroll

23 light source

1. An electronically updatable display comprising:
an electronically updatable display media having two or more areas, wherein at least two areas have a different color set; and
at least one view area, wherein at least a portion of the media is viewable through the view area, and
wherein the view area and the media are movable relative to one another.

2. The display of claim 1, wherein the display media comprises two or more media pieces, each media piece having one or more color sets.

3. The display of claim 2, wherein at least a portion of a first media piece overlaps at least a portion of a second media piece.

4. The display of claim 2, wherein the media pieces are joined.

5. The display of claim 2, wherein a first media piece and a second media piece are each movable relative to each other.

6. The display of claim 1, wherein the media comprises a loop, a scroll, or a sheet.

7. The display of claim 1, wherein the portion of the display media viewable through the view area comprises a single color set.

8. The display of claim 1, wherein the portion of the display media viewable through the view area comprises two or more color sets.

9. The display of claim 1, wherein the display comprises at least two view areas, and wherein the portion of the display media viewable through each view area comprises the same one or more color set.

10. The display of claim 1, wherein the display comprises at least two view areas, and the portion of the display media viewable through at least one view area comprises a different one or more color set from the display media viewable through at least one other view area.

11. The display of claim 1, further comprising at least one light source adjacent at least one portion of the media.

12. The display of claim 1, wherein at least a portion of the media is transmissive, reflective, or transparent.

13. A method of changing a display, the display comprising an electronically updatable media having two or more areas, wherein at least two areas have a different color set; and at least one view area, wherein at least a portion of the media is viewable through the view area, and wherein the view area and the media are movable relative to one another, the method comprising:
moving the media and view area relative to one another to display at least a portion of the media having a different color set.

14. The method of claim 13, wherein the view area is movable.

15. The method of claim 13, wherein the media is movable.

16. The method of claim 13, wherein the display media comprises two or more media pieces, each media piece having one or more color sets.

17. The method of claim 16, wherein at least a portion of a first media piece overlaps at least a portion of a second media piece.

18. The method of claim 16, wherein the media pieces are joined.

19. The method of claim 16, wherein a first media piece and a second media piece are each movable relative to each other to affect a change in color set.
